(19) United States
(12) Patent Application Publication
(10) Pub. No.: US 2024/0045526 A1
(43) Pub. Date: Feb. 8, 2024

(54) TOUCH MODULE AND TOUCH DISPLAY APPARATUS

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventor: Xueqiang ZHANG, Shenzhen, Guangdong (CN)

(73) Assignee: SHENZHEN CHINA STAR OPTOELECTRONICS SEMICONDUCTOR DISPLAY TECHNOLOGY CO., LTD., Shenzhen, Guangdong (CN)

(21) Appl. No.: 17/600,361

(22) PCT Filed: Sep. 7, 2021
(86) PCT No.: PCT/CN2021/116843

§ 371 Date: Sep. 30, 2021

(30) Foreign Application Priority Data
Aug. 9, 2021 (CN) 202110906878.1

(51) Int. Cl. G06F 3/041

(52) U.S. Cl. CPC G06F 3/041; G06F 2203/04107

(57) ABSTRACT

The present application provides a touch module and a touch display apparatus. The touch module includes a touch region, where a first electrode layer is arranged in the touch region. The first electrode layer includes: first touch electrodes located in the touch region, where the first touch electrodes are arranged in a first direction; and first traces each connected to the first touch electrode, where the first trace is arranged on a middle portion of the first touch electrode and extends in a second direction from the inside of the touch region toward the outside of the touch region, and the first direction and the second direction intersect.

### TECHNICAL FIELD

The present application relates to display device technologies, and more particularly, to touch module and a touch display apparatus.

### BACKGROUND

Full touch corresponding to a full screen technology is a research hotspot and cutting-edge technology in the current field of electronic touch, and has broad application prospects and huge market potential. The full screen technology is the hottest technology in the market, but due to current needs for wiring of an out-cell touch screen, it is impossible to achieve true bezel-less touch, and thus a true bezel-less full screen cannot be implemented.

### SUMMARY

The present application provides a touch module and a touch display apparatus, to solve the problem that an existing touch module has redundant bezels on both sides.

The present application provides a touch module, including a touch region, where a first electrode layer is arranged in the touch region, and the first electrode layer includes:
first touch electrodes located in the touch region, where the first touch electrodes are arranged in a first direction and configured to transmit a touch detection signal; and
first traces each connected to the first touch electrode, where the first trace is arranged on a middle portion of the first touch electrode and extends in a second direction from the inside of the touch region toward the outside of the touch region, and the first direction and the second direction intersect.

In the touch module according to the present application, the first touch electrodes and the first traces are arranged at the same layer;
the first touch electrodes each include a first touch sub-electrode and a second touch sub-electrode, and the first touch sub-electrode and the second touch sub-electrode are spaced in the first direction; and
the first traces each include a first sub-trace and a second sub-trace, the first sub-trace is connected to one end of the first touch sub-electrode, and the second sub-trace is connected to one end of the second touch sub-electrode close to the first touch sub-electrode.

In the touch module according to the present application, the first touch electrode is disconnected from the middle to form the first touch sub-electrode and the second touch sub-electrode, and a blank region is formed at the middle of the first touch electrode, so that the first touch sub-electrode and the second touch sub-electrode are located on two sides of the touch region, respectively.

In the touch module according to the present application, a width of each of the first traces is in the range of 5-10 km.

In the touch module according to the present application, the first traces are each arranged on the first touch electrode, and the first electrode layer further includes:
an insulating layer arranged on the first touch electrodes, where a middle portion of the insulating layer is provided with via holes, the first traces each fill the via hole and are in contact with the first touch electrode, and the first trace partly covers the insulating layer.

The touch module according to the present application further includes:
a first binding region arranged on one side outside the touch region, where a first binding terminal is arranged in the first binding region, one end of each of the first traces is located in the via hole, and the other end thereof is connected to the first binding terminal.

In the touch module according to the present application, the first traces each are a transparent trace.

In the touch module according to the present application, there are a plurality of first touch electrodes, and a distance between adjacent first touch electrodes ranges from 5 mm to 10 mm.

In the touch module according to the present application, the touch module further includes a second electrode layer stacked with the first electrode layer, and the second electrode layer includes:
second touch electrodes located in the touch region, where the second touch electrodes are arranged in the second direction and configured to receive the touch detection signal emitted by the first touch electrodes; and
second traces each connected to one end of the second touch electrode, where the second trace extends from the inside of the touch region toward the outside of the touch region.

The touch module according to the present application further includes:
an optical adhesive layer arranged between the first electrode layer and the second electrode layer, where the optical adhesive layer covers the first traces; and
a cover plate covering the second electrode layer.

The present application further provides a touch display apparatus, including:
a display panel, configured to display an image;
a touch module stacked with the display panel and configured to recognize a touch operation to control the display panel to display the image, where the touch module includes a touch region, a first electrode layer is arranged in the touch region, and the first electrode layer includes:
first touch electrodes located in the touch region, where the first touch electrodes are arranged in a first direction and configured to transmit a touch detection signal; and
first traces each connected to the first touch electrode, where the first trace is arranged on a middle portion of the first touch electrode and extends in a second direction from the inside of the touch region toward the outside of the touch region, and the first direction and the second direction intersect.

In the touch display apparatus according to the present application, the first touch electrodes and the first traces are arranged at the same layer;
the first touch electrodes each include a first touch sub-electrode and a second touch sub-electrode, and the first touch sub-electrode and the second touch sub-electrode are spaced in the first direction; and
the first traces each include a first sub-trace and a second sub-trace, the first sub-trace is connected to one end of the first touch sub-electrode, and the second sub-trace is connected to one end of the second touch sub-electrode close to the first touch sub-electrode.

In the touch display apparatus according to the present application, the first touch electrode is disconnected from the middle to form the first touch sub-electrode and the second touch sub-electrode, and a blank region is formed at the middle of the first touch electrode, so that the first touch sub-electrode and the second touch sub-electrode are located on two sides of the touch region, respectively.

In the touch display apparatus according to the present application, a width of each of the first traces is in the range of 5-10 μm.

In the touch display apparatus according to the present application, the first traces are each arranged on the first touch electrode, and the first electrode layer further includes:
an insulating layer arranged on the first touch electrodes, where a middle portion of the insulating layer is provided with via holes, the first traces each fill the via hole and are in contact with the first touch electrode, and the first trace partly covers the insulating layer.

In the touch display apparatus according to the present application, the touch module further includes:
a first binding region arranged on one side outside the touch region, where a first binding terminal is arranged in the first binding region, one end of each of the first traces is located in the via hole, and the other end thereof is connected to the first binding terminal.

In the touch display apparatus according to the present application, the first traces each are a transparent trace.

In the touch display apparatus according to the present application, there are a plurality of first touch electrodes, and a distance between adjacent first touch electrodes ranges from 5 mm to 10 mm.

In the touch display apparatus according to the present application, the touch module further includes a second electrode layer stacked with the first electrode layer, and the second electrode layer includes:
second touch electrodes located in the touch region, where the second touch electrodes are arranged in the second direction and configured to receive the touch detection signal emitted by the first touch electrodes; and
second traces each connected to one end of the second touch electrode, where the second trace extends from the inside of the touch region toward the outside of the touch region.

In the touch display apparatus according to the present application, the touch module further includes:
an optical adhesive layer arranged between the first electrode layer and the second electrode layer, where the optical adhesive layer covers the first traces; and
a cover plate covering the second electrode layer.

The present application has the beneficial effects that first touch electrodes for emitting a touch detection signal extend in a second direction, and first traces each are arranged on a middle portion of the first touch electrode and extend from the inside of a touch region toward the outside of the touch region, so that the first trace extends from the middle portion of the touch region toward the outside of the touch region in a first direction intersecting with the second direction. This prevents the first trace from extending from two sides of the first touch electrode toward the outside of the touch region and avoids occupying redundant bezels on both sides, thereby facilitating the implementation of no bezels.

### BRIEF DESCRIPTION OF DRAWINGS

The following detailed description of the specific implementations of the present application with reference to accompanying drawings makes the technical solutions and other beneficial effects of the present application apparent.

FIG. 1 is a schematic top structural view of a first electrode layer of a touch module according to an embodiment of the present application;

FIG. 2 is a schematic top structural view of a first electrode layer of a touch module according to another embodiment of the present application;

FIG. 3 is a schematic cross-sectional structural diagram of a touch module according to an embodiment of the present application;

FIG. 4 is a schematic cross-sectional structural diagram of a touch module according to still another embodiment of the present application; and

FIG. 5 is a schematic structural diagram of a second electrode layer of a touch module according to an embodiment of the present application.

### DESCRIPTION OF EMBODIMENTS

The technical solutions in the embodiments of the present application are clearly and completely described below with reference to the accompanying drawings in the embodiments of the present application. Apparently, the described embodiments are merely some rather than all of the embodiments of the present application. Based on the embodiments of the present application, all other embodiments obtained by a person skilled in the art without creative efforts shall fall within the protection scope of the present application.

In the description of the present application, it should be understood that the orientation or positional relationship indicated by the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise” and “counterclockwise” is based on the orientation or positional relationship shown in the accompanying drawings, and is only for the convenience of describing the present application and simplifying the description, rather than indicating or implying that the apparatus or component referred to must have a specific orientation, be constructed and operated in a specific orientation, which therefore cannot be understood as a limitation to the present application. In addition, the terms “first” and “second” are used for description only, and cannot be understood as indicating or implying relative importance or implicitly indicating the number of indicated technical features. Therefore, the features defined with “first” and “second” may include one or more of the features explicitly or implicitly. In the description of the present application, “a plurality of” means two or more, unless otherwise specifically defined.

In the description of the present application, it should be noted that, unless otherwise specified and defined, the terms, “mount”, “connected to”, “connect”, etc. should be understood in a broad sense, for example, a connection may be a fixed connection, or a detachable connection, or an integrated connection; or a mechanical connection or an electric connection or mutual communication; or a direct connection, an indirect connection through an intermediate medium, or internal communication between two elements or a relationship of interaction between two elements. For a person of ordinary skill in the art, the specific meanings of the above-mentioned terms in the present application may be understood based on specific conditions.

The following disclosure provides many different implementations or examples to implement different structures of the present application. To simplify the disclosure of the present application, components and arrangements of specific examples are described below. Certainly, they are merely examples and are not intended to limit the present application. In addition, in the present application, references may be repeatedly made to numerals and/or reference letters in different examples. The repetition is for simplification and clarity, and the repetition itself does not indicate the relationship between the various implementations and/or arrangements described. In addition, the present application provides examples of various specific processes and materials, but a person of ordinary skill in the art may be aware of application of other processes and/or use of other materials.

The touch module and the touch display apparatus according to the embodiments of the present application are separately introduced in detail below.

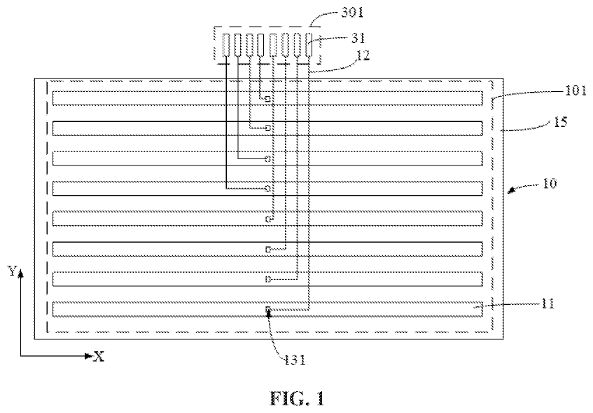

Referring to FIG. 1, an embodiment of the present application provides a touch module, including a touch region 101, where a first electrode layer 10 is arranged in the touch region 101, and the first electrode layer 10 includes first touch electrodes 11 and first traces 12.

The first touch electrodes 11 are located in the touch region 101, arranged in a first direction X and configured to transmit a touch detection signal.

The first traces 12 each are connected to the first touch electrode 11, the first trace 12 is arranged on a middle portion of the first touch electrode 11 and extends in a second direction Y from the inside of the touch region 101 toward the outside of the touch region 101, and the first direction X and the second direction Y intersect. Specifically, in this embodiment, the first direction X is perpendicular to the second direction Y, the first direction X is a horizontal direction, and the second direction Y is a vertical direction.

In the touch module according to the embodiment of the present application, first touch electrodes 11 for emitting a touch detection signal extend in a second direction Y, and first traces 12 each are arranged on a middle portion of the first touch electrode 11 and extend from the inside of a touch region 101 toward the outside of the touch region 101, so that the first trace 12 extends from the middle portion of the touch region 101 toward the outside of the touch region 101 in a first direction intersecting with the second direction. This prevents the first trace 12 from extending from two sides of the first touch electrode 11 toward the outside of the touch region 101 and avoids occupying redundant bezels on both sides, thereby facilitating the implementation of no bezels.

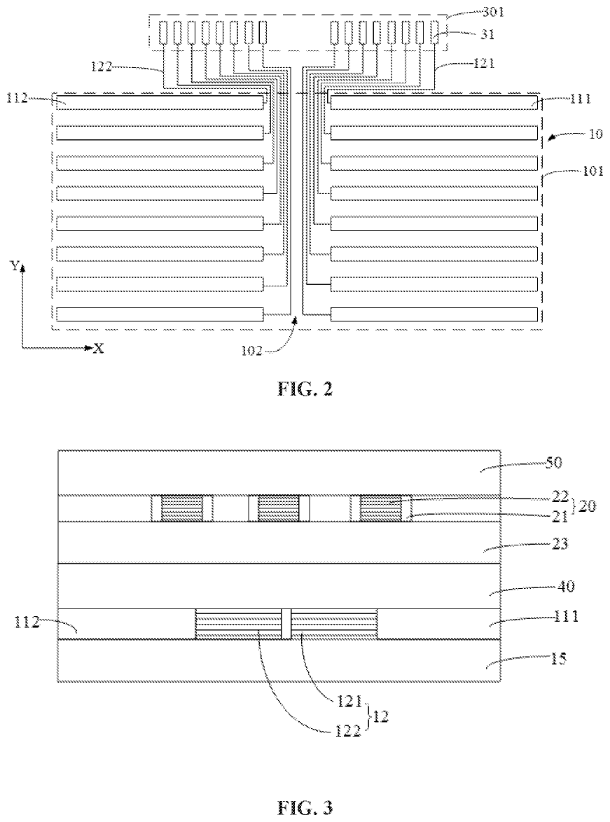

In some embodiments, referring to FIG. 2 and FIG. 3, the first touch electrodes 11 and the first traces 12 are arranged at the same layer.

The first touch electrodes 11 each include a first touch sub-electrode 111 and a second touch sub-electrode 112, and the first touch sub-electrode 111 and the second touch sub-electrode 112 are spaced in the first direction X. Specifically, the first touch electrode 11 is disconnected from the middle to form the first touch sub-electrode 111 and the second touch sub-electrode 112, and a blank region 102 is formed at the middle of the first touch electrode 11, so that the first touch sub-electrode 111 and the second touch sub-electrode 112 are located on two sides of the touch region 101, respectively.

The first traces 12 each include a first sub-trace 121 and a second sub-trace 122, the first sub-trace 121 is connected to one end of the first touch sub-electrode 111, and the second sub-trace 122 is connected to one end of the second touch sub-electrode 112 close to the first touch sub-electrode 111. Specifically, the first sub-trace 121 and the second sub-trace 122 are located in the blank region 102 formed by disconnecting the first touch electrode 11 from the middle, and the first sub-trace 121 and the second sub-trace 122 are spaced.

In this embodiment, the first touch electrode 11 is disconnected from the middle to form the first touch sub-electrode 111 and the second touch sub-electrode 112, so that the first sub-trace 121 and the second sub-trace 122 are located in disconnected positions at the middle of the first touch electrode 11 and extend from the touch region 101 to the outside of the touch region 101. This prevents the first trace 12 from extending from two sides of the first touch electrode 11 toward the outside of the touch region 101 and avoids occupying redundant bezels on both sides, thereby facilitating the implementation of no bezels.

In some embodiments, there are a plurality of first touch electrodes 11. Specifically, each of the first touch electrodes 11 extends in the first direction X, the plurality of first touch electrodes 11 are spaced in the second direction Y, each of the first touch electrodes 11 is connected to one first trace 12, and a distance between adjacent first touch electrodes 11 ranges from 5 mm to 10 mm. For example, the distance between two adjacent first touch electrodes 11 may be set to 5 mm, 7 mm, 10 mm, or the like.

It can be understood that when the area of the touch region 101 is constant, a smaller distance between two adjacent first touch electrodes 11 indicates a greater number of first touch electrodes 11 that may be set, and higher touch accuracy that the touch module can achieve. However, a greater load of a driver IC connected to the first touch electrode 11 indicates a higher cost. Similarly, a greater distance between two adjacent first touch electrodes 11 indicates a smaller number of first touch electrodes 11 that can be arranged, and a lower manufacturing cost, but lower touch accuracy that may be implemented. Therefore, in the embodiment of the present application, the distance between adjacent first touch electrodes 11 is set in the range of 5 mm to 10 mm, i.e., the distance between the first touch electrodes 11 is controlled within a reasonable range, so that the manufacturing cost of the touch module is controlled while the touch accuracy of the touch module is ensured.

Still referring to FIG. 2 and FIG. 3, in some embodiments, a width of each of the first traces 12 is in the range of 5-10 μm. For example, the width of the first trace 12 may be 5 μm, 7 μm, or 10 μm. Specifically, a width of the first sub-trace 121 and a width of the second sub-trace 122 are also in the range of 5-10 μm, and the width range of the first sub-trace 121 and the width range of the second sub-traces 122 may be the same or different, which is not specifically limited herein. The blank region 102 is formed in the disconnected position at the middle of the first touch electrode 11 and configured to accommodate the first sub-trace 121 and the second sub-trace 122. To ensure a reasonable distance between traces and prevent short circuits between the traces, the traces connected to each touch electrode are spaced. When there are a greater number of first touch electrodes 11, accordingly, the number of the first sub-traces 121 and the second sub-traces 122 accommodated in the blank region 102 also increases, then the blank region 102 also becomes larger. The blank region 102 is a touch invalid region, i.e., a touch function cannot be realized, but by controlling the blank region 102 in a reasonable range, the normal touch function of the overall touch module can still be realized. Therefore, to prevent the blank region 102 between the first touch sub-electrode 111 and the second touch sub-electrode 112 from being excessively large and affecting the touch accuracy, the width of each of the first traces 12 is set in a reasonable range, so as to ensure the touch accuracy of the touch module.

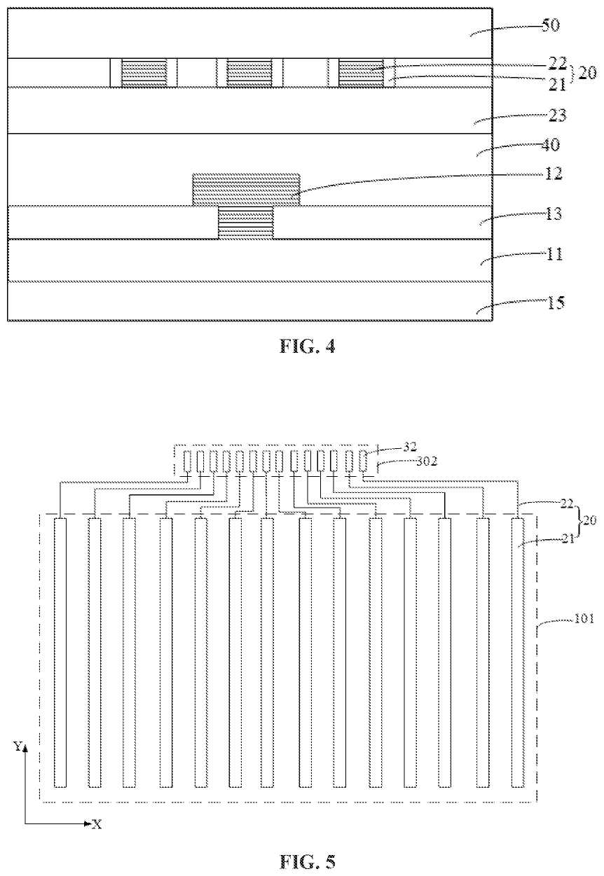

As shown in to FIG. 1 and FIG. 4, in some embodiments, the first traces 12 each are arranged on one first touch electrode 11, and the first electrode layer 10 further includes an insulating layer 13.

The insulating layer 13 is arranged on the first touch electrodes 11, and a middle portion of the insulating layer 13 is provided with via holes 131. Specifically, the middle portion of the insulating layer 13 is provided with via holes 131 in the first direction X, and the via holes 131 run through the insulating layer 13. The first traces 12 each fill the via hole 131 and are in contact with the first touch electrode 11, and the first trace 12 partly covers the insulating layer 13.

In this embodiment, through the arrangement of the via hole 131, the first trace 12 may also be connected to the middle portion of the first touch electrode 11 without disconnecting the first touch electrode 11, so that the first trace 12 extends from the touch region 101 to the outside of the touch region 101. This prevents the first trace 12 from extending from two sides of the first touch electrode 11 toward the outside of the touch region 101 and avoids occupying redundant bezels on both sides, thereby facilitating the implementation of no bezels.

In some embodiments, the touch module further includes a first binding region 301, where the first binding region 301 is arranged on one side outside the touch region 101.

A first binding terminal 31 is arranged in the first binding region 301. The first binding terminal 31 is connected to the first touch electrode 11 through the first trace 12, one end of the first trace 12 is located in the via hole 131 and is connected to the first touch electrode 11 through the via hole 131, and the other end thereof is connected to the first binding terminal 31. When there are a plurality of first traces 12, each of the first traces 12 is connected to one first binding terminal 31 in the first binding region 301.

In some embodiments, the first traces 12 each are a transparent trace. Specifically, the first trace 12 may be made of a transparent conductive material with low resistance, such as an ITO-Al-ITO (IAI) coating and a metal coating, where the metal coating may be a silver (Ag) coating, an aluminum (Al) coating, etc., and a thickness of the metal coating is enabled to be less than 10 nm by surface treatment on the metal coating, thus achieving the effect of transparency. The touch module, especially an out-cell touch module, is attached to a display panel, so that the touch region 101 overlaps a display region of the display panel. In the embodiment of the present application, since the second trace 22 is arranged in the touch region 101, compared with using a non-transparent trace such as a silver colloid wire or a copper wire as an existing first trace 12, arranging the first trace 12 as a transparent trace is more conducive to preventing the first trace 12 in the touch region 101 from affecting image display, thereby ensuring subsequent display effects.

In addition, the first trace 12 and the first touch electrode 11 may be made of the same material, which is beneficial to simplifying a manufacturing process of the touch module, thereby being favorable for reducing costs.

In some embodiments, as shown in FIG. 4 and FIG. 5, the touch module further includes a second electrode layer 20 stacked with the first electrode layer 10, the first electrode layer 10 is insulated from the second electrode layer 20, and the second electrode layer 20 includes second touch electrodes 21 and second traces 22.

The second touch electrodes 21 are located in the touch region 101, arranged in the second direction Y and configured to receive the touch detection signal emitted by the first touch electrodes 11, so as to achieve a touch function of the touch module.

The second traces 22 each are connected to one end of the second touch electrode 21, where the second trace 22 extends from the inside of the touch region 101 toward the outside of the touch region 101. Specifically, the second traces 22 each extend from the inside of the touch region 101 toward a second binding region 302 outside the touch region 101, and each of the second traces 22 is connected to one second binding terminal 32 in the second binding region 302. The second binding region 302 and the first binding region 301 may be overlapping regions located on the same side outside the touch region 101, for example, on the same side in the second direction Y, or may be located on two opposite sides outside the touch region 101, for example, are respectively located on different two sides in the second direction Y, respectively.

There are a plurality of second touch electrodes 21. Specifically, each of the second touch electrodes 21 extends in the second direction Y, the plurality of second touch electrodes 21 are spaced in the first direction X, and each of the second touch electrodes 21 is connected to one second trace 22.

For example, the first touch electrodes 11 and the second touch electrodes 21 may each have a rhombic or triangular shape or another shape, which is not specifically limited herein.

In some embodiments, the touch module further includes a first substrate 15 and a second substrate 23, where the first electrode layer 10 is arranged on the first substrate 15, and the second electrode layer 20 is arranged on the second substrate 23. Both the first substrate 15 and the second substrate 23 may be made of a polyethylene terephthalate (PET) material.

In some embodiments, referring to FIG. 5, the touch module further includes an optical adhesive layer 40 and a cover plate 50.

The optical adhesive layer 40 is arranged between the first electrode layer 10 and the second electrode layer 20, and the optical adhesive layer 40 covers the first traces 12. For example, when the first traces 12 each include a first sub-trace 121 and a second sub-trace 122, the optical adhesive layer 40 is used for filling between the first sub-trace 121 and the second sub-trace 122, which can protect the first sub-trace 121 and the second sub-trace 122. In addition, when the first traces 12 are arranged in the via holes 131, the optical adhesive layer 40 is used for filling between the insulating layer 13 and the second substrate 23, and the optical adhesive layer 40 is configured to bond the first electrode layer 10 to the second electrode layer 20. The optical adhesive layer 40 may be, for example, a transparent OCA, which is not specifically limited herein.

The cover plate 50 covers the second electrode layer 20, and the cover plate 50 is configured to protect an internal structure of the touch module, such as preventing water, vapor, etc. from entering the touch module, which is beneficial to prolonging the service life.

To better implement the touch module of the present application, an embodiment of the present application further provides a touch display apparatus, including a display panel and a touch module.

The display panel is configured to display an image, and the touch module is stacked with the display panel and configured to recognize a touch operation to control the display panel to display the image. Since the display apparatus has the above-mentioned touch module, the display apparatus has all the same beneficial effects, which will not be repeated in this embodiment.

In the embodiments of the present application, no specific limitation is performed on the application of the touch display apparatus. The touch display apparatus may be a television set, a notebook computer, a tablet computer, a wearable display device (such as smartband and a smartwatch), a mobile phone, a virtual reality device, an augmented reality device, an in-vehicle display, an advertising light box or any other product or component with a display function.

In the above-mentioned embodiments, the description of each embodiment has its own emphasis. For parts that are not described in detail in an embodiment, reference may be made to related descriptions of other embodiments.

The touch module and the touch display apparatus according to embodiments of the present application are described in detail above. Specific examples are applied herein to illustrate the principle and implementations of the present application. The description of the above-mentioned embodiments is only used to help understand the technical solutions of the present application and the core idea thereof. A person of ordinary skill in the art should understand that he/she may still modify the technical solutions described in the foregoing embodiments, or equivalently replace some of the technical features therein. However, these modifications or replacements do not make the essence of the corresponding technical solutions depart from the scope of the technical solutions of each embodiment of the present application.

What is claimed is:

1. A touch module, comprising a touch region, wherein a first electrode layer is arranged in the touch region, and the first electrode layer comprises:
first touch electrodes located in the touch region, wherein the first touch electrodes are arranged in a first direction and configured to transmit a touch detection signal; and
first traces each connected to the first touch electrode, wherein each of the first trace is arranged on a middle portion of the first touch electrode and extends in a second direction from inside of the touch region toward outside of the touch region, and the first direction and the second direction intersect.

2. The touch module according to claim 1, wherein the first touch electrodes and the first traces are arranged at a same layer;
the first touch electrodes each comprise a first touch sub-electrode and a second touch sub-electrode, and the first touch sub-electrode and the second touch sub-electrode are spaced in the first direction; and
the first traces each comprise a first sub-trace and a second sub-trace, the first sub-trace is connected to one end of the first touch sub-electrode, and the second sub-trace is connected to one end of the second touch sub-electrode close to the first touch sub-electrode.

3. The touch module according to claim 1, wherein the first touch electrode is disconnected from the middle to form the first touch sub-electrode and the second touch sub-electrode, a blank region is formed at the middle of the first touch electrode, and the first touch sub-electrode and the second touch sub-electrode are located on two sides of the touch region, respectively.

4. The touch module according to claim 2, wherein a width of each of the first traces i ranges from 5 μm to 10 μm.

5. The touch module according to claim 1, wherein the first traces are each arranged on the first touch electrode, and the first electrode layer further comprises:
an insulating layer arranged on the first touch electrodes, wherein a middle portion of the insulating layer is provided with via holes, the first traces each fill the via hole and are in contact with the first touch electrode, and the first trace partly covers the insulating layer.

6. The touch module according to claim 5, further comprising:
a first binding region arranged on one side outside the touch region, wherein first binding terminals are arranged in the first binding region, one end of each of the first traces is located in the via hole, and the other end thereof is connected to the first binding terminal.

7. The touch module according to claim 1, wherein the first traces each are a transparent trace.

8. The touch module according to claim 1, wherein a quantity of the first touch electrodes is plurality, and a distance between adjacent first touch electrodes ranges from 5 mm to 10 mm.

9. The touch module according to claim 1, further comprising a second electrode layer stacked with the first electrode layer, wherein the second electrode layer comprises:
second touch electrodes located in the touch region, wherein the second touch electrodes are arranged in the second direction and configured to receive the touch detection signal emitted by the first touch electrodes; and
second traces each connected to one end of the second touch electrode, wherein the second trace extends from the inside of the touch region toward the outside of the touch region.

10. The touch module according to claim 9, further comprising:
an optical adhesive layer arranged between the first electrode layer and the second electrode layer, wherein the optical adhesive layer covers the first traces; and
a cover plate covering the second electrode layer.

11. A touch display apparatus, comprising:
a display panel configured to display an image;
a touch module stacked with the display panel and configured to recognize a touch operation to control the display panel to display the image, wherein the touch module comprises a touch region, a first electrode layer is arranged in the touch region, and the first electrode layer comprises:
first touch electrodes located in the touch region, wherein the first touch electrodes are arranged in a first direction and configured to transmit a touch detection signal; and
first traces each connected to the first touch electrode, wherein each of the first trace is arranged on a middle portion of the first touch electrode and extends in a second direction from inside of the touch region toward outside of the touch region, and the first direction and the second direction intersect.

12. The touch display apparatus according to claim 11, wherein the first touch electrodes and the first traces are arranged at a same layer;
the first touch electrodes each comprise a first touch sub-electrode and a second touch sub-electrode, and the first touch sub-electrode and the second touch sub-electrode are spaced in the first direction; and
the first traces each comprise a first sub-trace and a second sub-trace, the first sub-trace is connected to one end of the first touch sub-electrode, and the second sub-trace is connected to one end of the second touch sub-electrode close to the first touch sub-electrode.

13. The touch display apparatus according to claim 11, wherein the first touch electrode is disconnected from the middle to form the first touch sub-electrode and the second touch sub-electrode, a blank region is formed at the middle of the first touch electrode, and the first touch sub-electrode and the second touch sub-electrode are located on two sides of the touch region, respectively.

14. The touch display apparatus according to claim 12, wherein a width of each of the first traces ranges from 5 μm to 10 μm.

15. The touch display apparatus according to claim 11, wherein the first traces are each arranged on the first touch electrode, and the first electrode layer further comprises:
an insulating layer arranged on the first touch electrodes, wherein a middle portion of the insulating layer is provided with via holes, the first traces each fill the via hole and are in contact with the first touch electrode, and the first trace partly covers the insulating layer.

16. The touch display apparatus according to claim 15, wherein the touch module further comprises:
a first binding region arranged on one side outside the touch region, wherein first binding terminals are arranged in the first binding region, one end of each of the first traces is located in the via hole, and the other end thereof is connected to the first binding terminal.

17. The touch display apparatus according to claim 11, wherein the first traces each are a transparent trace.

18. The touch display apparatus according to claim 11, wherein a quantity of the first touch electrodes is plurality, and a distance between adjacent first touch electrodes ranges from 5 mm to 10 mm.

19. The touch display apparatus according to claim 11, wherein the touch module further comprises a second electrode layer stacked with the first electrode layer, and the second electrode layer comprises:
second touch electrodes located in the touch region, wherein the second touch electrodes are arranged in the second direction and configured to receive the touch detection signal emitted by the first touch electrodes; and
second traces each connected to one end of the second touch electrode, wherein the second trace extends from the inside of the touch region toward the outside of the touch region.

20. The touch display apparatus according to claim 19, wherein the touch module further comprises:
an optical adhesive layer arranged between the first electrode layer and the second electrode layer, wherein the optical adhesive layer covers the first traces; and
a cover plate covering the second electrode layer.
